(19) United States
(12) Patent Application Publication
(10) Pub. No.: US 2014/0200946 A1
(43) Pub. Date: Jul. 17, 2014

(54) METHODS AND SYSTEMS FOR INVENTORY OPTIMIZATION

(71) Applicant: FLUOR TECHNOLOGIES CORPORATION, Aliso Viejo, CA (US)

(72) Inventors: Jim Humphries, Greenville, SC (US); Charlton Pence, Greenville, SC (US)

(73) Assignee: FLUOR TECHNOLOGIES CORPORATION, Aliso Viejo, CA (US)

(21) Appl. No.: 13/742,202

(22) Filed: Jan. 15, 2013

(51) Int. Cl. G06Q 10/06

(52) U.S. Cl. CPC G06Q 10/06315
USPC 705/7.25

(57) ABSTRACT

An inventory optimization system is disclosed. The system comprises of an inventory interface configured to receive inventory policy criteria representing possible conditions of a plurality of inventory policies by which an inventory could be managed. An optimization engine is provided to generate the plurality of inventory policies based on the inventory policy criteria with each inventory policy having an assumed future demand model. The optimization engine is also configured to use a simulation engine to simulate how each inventory policy would perform (i.e. a cost to run the inventory policy) under different estimated demand. The optimization engine is configured to rank the plurality of inventory policies based on their performance under the simulations.

### FIELD OF THE INVENTION

The present disclosure relates generally to inventory management, and more particularly to a system and method of identifying optimized inventory policy.

### BACKGROUND

The following description includes information that may be useful in understanding the present invention. It is not an admission that any of the information provided herein is prior art or relevant to the presently claimed invention, or that any publication specifically or implicitly referenced is prior art.

In today's business world, inventory management plays a vital role in a company's competence and productivity. An inventory can include raw materials, work-in-progress materials, final product or spare parts of machine(s) used in a production process, especially within a large capital construction project or program. High inventory levels can significantly increase carrying costs and handling costs in a business. To manage inventory resources efficiently, businesses must accurately keep track of inventory count, maintain a sufficient amount of inventory on stock, and timely re-stock an appropriate amount of inventory. It is extremely difficult to uphold adequate inventory on stock that sustains a sufficient amount of stock to allow the machine(s) to continue to run without interruptions and/or satisfactorily fulfill customers' orders without over-stocking the inventory. A delicate equilibrium is essential to avoid over-stocking, which poses many risks such as tying up funds and incurring maintenance costs, including storage space expense, spoilage and damage, and depreciation of inventory value. Maximizing the efficiency of the inventory management is extremely critical and can play a major role in the success of a business.

In addition to upholding a proper level of inventory on stock, timelines of restocking is crucial in planning for future orders to prevent stock-outs. As discussed herein, a stock-out refers to the situation in which sufficient inventories are not available resulting in interruptions to business operations and/or a delay in meeting one or more customer orders. Thus, the ability for a business to determine when material replenishment may need to occur and the appropriate replenishment amount is essential in maintaining a low level of inventory while preventing stock-outs.

Further, forecasting future demand is another key factor in properly managing the inventory portfolio. To avoid stock-outs and to reduce costs associated with holding inventory, it is common for managers to predict inventory levels by forecasting demand from a set of historical data. However, this type of forecasting is often challenging for inventory with limited historical data. For example, some inventory may only have quarterly inventory information going back one year.

Even if sufficient historical data is available, there can still arise a scenario wherein the forecasted demand contains error and in which scenario, the predict inventory levels may not be accurate. Thus, the aforesaid methods of inventory management fail to provide satisfactory result.

Various computer implemented methods for optimizing inventory management have been developed. A few examples have been indicated below such as U.S. Pat. No. 8,140,396 to Suguro titled “Safety Stock Amount Calculation Method, Safety Stock Amount Calculation Device, Reorder Point Calculation Method, Reorder Point Calculation Device, and Order Quantity Calculation Method”, filed Mar. 11, 2011, which describes a safety stock amount calculation method that takes into account the error between actual individual demand and corresponding predicted demand. Another example is EP Patent No. 1,550,623 to Yoshida et al., titled “Inventory Management Method, Inventory Management System, and Inventory Management Program”, filed Oct. 7, 2003, which describes an inventory management method and system for controlling amounts of stocks and particularly describes utilizing statistical techniques to effectively derive inventory information. Yet another example is U.S. Patent Publication No. 2002/0072977 to Hoblit et al., titled “Analyzing Inventory Using Time Frames”, filed Dec. 7, 2000, which describes a method to notify the interested party when the sales of a particular item are deviated from the predicted amount. Yet another example is U.S. Pat. No. 5,963,919 to Brinkley et al., titled “Inventory Management Strategy Evaluation System and Method”, filed Dec. 23, 1996, which describes using different inventory strategies on different items. Yet another example is US Patent Publication No. 2008/0215180 to Kota titled “Arrangement for Dynamic Lean Replenishment and Methods Therefor”, filed Mar. 2, 2007, which describes a dynamic lean replenishment method for handling inventory management and particularly describes performing an analysis each time, consumption has occurred or performing an analysis after a preset time interval. The analysis involves comparing the projected inventory stock to a safety stock to determine replenishment. Yet another example is US Patent Publication No. 2007/0294146 to Laksham et al., titled “Apparatus and Method for Optimizing Inventory in a Production Operation”, filed Jun. 8, 2006, which describes a method for analyzing inventory by providing three curves based on the historical data including actual inventory level, consumption level, and optimal inventory level.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

However, all of the above-mentioned references determine inventory levels by predicting future performance based on historic data. As mentioned above, historic data often times provide bad indications to future performance. Thus, there is a need to have a system that takes into account the likelihood and impact of errors in the prediction of future performance when determining inventory levels.

### SUMMARY OF THE INVENTION

In one aspect of the invention, an inventory optimization system for determining an optimized inventory policy is disclosed. In some embodiments, the system comprises of an inventory interface configured to receive inventory policy criteria representing possible conditions of a plurality of inventory policies by which an inventory could be managed. An optimization engine is provided to be in communication with the inventory interface and configured to receive the inventory policy criteria via the interface. The optimization engine further configured to generate the plurality of inventory policies based on the inventory policy criteria with each inventory policy having an assumed future demand model. A simulation engine is provided to be in communication with the optimization engine and configured to estimate at least one deviation for each inventory policy's corresponding assumed future demand model. A cost analysis engine is provided to be in communication with the optimization engine and configured to estimate a policy cost for each inventory policy in the plurality of inventory policies derived from the at least one deviation in the corresponding assumed future demand model. An output interface is provided to be in communication with the optimization engine and configured to communicate with an output device to display a ranking of the plurality of inventory policies according to policy cost.

A method of identifying an optimized inventory policy in accordance with an embodiment of the invention is also disclosed. The method comprises of receiving inventory policy criteria representing possible conditions of a plurality of inventory policies by which an inventory could be managed. Further, a plurality of inventory policies based on the inventory policy criteria are generated with each inventory policy having an assumed future demand model. Further, at least one deviation for each inventory policy's corresponding the assumed future demand model is created and a policy cost is generated for each inventory policy in the plurality of inventory policies derived from the at least one deviation in the corresponding assumed future demand model. Finally, the plurality of inventory policies is ranked according to policy cost and are displayed on an output device.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic diagram of an inventory optimization system in accordance with an embodiment of the invention;

FIG. 2 is a schematic diagram showing different types of incurred cost in accordance with an embodiment of the invention;

FIG. 3 is a flowchart showing a method of identifying an optimized inventory policy in accordance with an embodiment of the invention;

FIG. 4 is a use case diagram illustrating an example environment in which the method of the present invention can be effectively utilized;

FIG. 5 is a use case diagram illustrating another example environment in which the method of the present invention can be effectively utilized; and

FIG. 6 is a hardware configuration of a computer system that is representative of a hardware environment for practicing the invention.

### DETAILED DESCRIPTION

Throughout the following discussion, numerous references will be made regarding servers, services, interfaces, portals, engines, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. Throughout the patent specification, a convention employed is that in the appended drawings, like numerals denote like components.

Reference throughout this specification to “an embodiment”, “another embodiment” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures proceeded by “comprises . . . a” does not, without more constraints, preclude the existence of other devices or other sub-systems or other elements or other structures or additional devices or additional sub-systems or additional elements or additional structures.

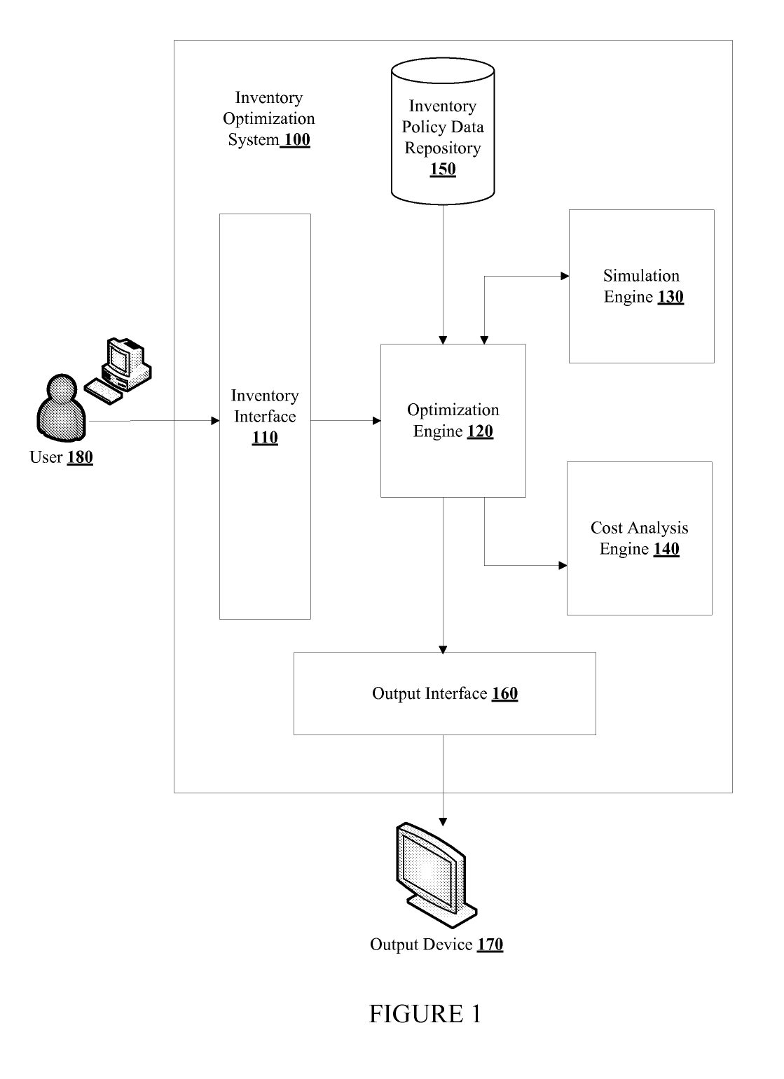

Embodiments of the present invention will be described below in detail with reference to the accompanying drawings. FIG. 1 illustrates an inventory optimization system 100 in accordance with an embodiment of the invention. As described herein, inventory is euphemistically defined as an amount of one or more items that is ready to be consumed by an organization. The one or more items can include stock to be sold to consumers, items or materials ready for use in a construction project, spare parts to be used in machineries for the organization, or other items or materials ready for use. As shown in FIG. 1, the inventory optimization system 100 comprises of an inventory interface 110, an optimization engine 120, a simulation engine 130, a cost analysis engine 140, an inventory policy data repository 150 and an output interface 160. In some embodiments, the inventory interface 110, the optimization engine 120, the simulation engine 130, the cost analysis engine 140 are implemented as modules (software or hardware modules) of the inventory optimization system 100.

As shown in FIG. 1, the inventory interface 110 is communicatively coupled with one or more user computers 180 and is configured to receive inventory policy criteria from users via computer(s) 180. Alternatively, the inventory interface 110 may also be configured to receive the inventory policy criteria from a website or an ERP module or a mobile communication device or any other known inventory software. According to an embodiment, the inventory policy criteria comprise a range of inventory levels, such as a range of desirable amounts of inventory that are available to be used/consumed at all time.

The optimization engine 120 is communicatively coupled with the inventory interface 110 and is configured to receive the inventory policy criteria from the inventory interface 110. The optimization engine 120 is also configured to generate a plurality of inventory policies based on inventory policy criteria received through the inventory interface 110 (step 220). According to an embodiment, each of the inventory policies generated by the optimization engine 120 comprises rules for managing one or more inventory items in a business. In some embodiments, each inventory policy is generated/designed around an associated assumed future demand model. That is, each inventory policy is specifically generated/designed to optimally fulfill a future demand under the associated future demand model with the least amount of cost. As such, the inventory policy of some embodiments also provides guidelines and sets forth the appropriate accounting policies to prevent losses or shortages, and to ensure that all inventory items including raw materials/parts, work in progress, and finished goods and consigned inventory, are properly controlled and accounted.

In some embodiments, the optimization engine 120 is further configured to determine a set of rules for each of the plurality of different inventory policies for governing maintenance of an inventory level within the range of inventory levels. The set of rules for an inventory policy specifies actions to be performed to maintain the associated inventory level for the inventory policy. For example, the set of rules for an inventory policy can specify one or more trigger points (e.g., when the inventory level drops below a certain threshold) for replenishing inventory, a replenishment amount, etc.

After generating the plurality of inventory policies, the optimization engine 120 of some embodiments estimates a future demand deviation for each future demand model associated with the inventory policies. The future demand deviations quantify how each of the future demand models deviates from a predicted future demand. Since the actual future demand may vary due to a variety of uncertainties in future conditions, the 120 addresses the risk of errors in predicting the future demand by using the Monte Carlos method. The Monte Carlo is a technique that converts uncertainties in input variables of a model into probability distributions.

According to the Monte Carlos method, the optimization engine 120 analyzes data such as the best case scenario, the worst case scenario, most likely scenario, and other market data to generate a probability distribution that represents the likelihood of different demand levels in the future (e.g., the next seven years). For example, a future demand probability distribution can look like this: there is a 40% chance of having an annual demand of 7 units for the next 10 years, a 20% chance of having an annual demand of 9 units for the next 10 years, a 20% chance of having an annual demand of 5 units for the next 10 years, a 10% chance of having an annual demand of 10 units for the next 10 years, and a 10% chance of having an annual demand of 4 units for the next 10 years.

The optimization engine 120 then uses the simulation engine 130 to run Monte Carlo simulations based on the generated probability distribution. To further address the risk of errors, the optimization engine 120 of some embodiments is configured to run a large number of simulations (e.g., preferably at least 50 simulations, more preferably at least 100 simulations, or even more preferably at least 1,000 simulations) to obtain the future demand deviation. For example, the optimization engine 120 can run the simulation 100 times to generate 100 scenarios representing the future demands of a certain machine spare part. The optimization engine 120 can then compute how each of the future demand models associated with the inventory policies deviates from the simulated annual demands. In addition, the optimization engine 120 can compute the costs that an entity would incur if it manages its inventory using each inventory policy under the simulated demand scenarios.

As mentioned above, the optimization engine 120 runs a number (e.g. 10, 50, 100, 1000, etc.) of simulations for the generated inventory polices. In some of these embodiments, the optimization engine 120 first generates a random future demand based on the Monte Carlo probability distribution, and then simulates how each inventory policy would perform under the generated random future demand. In addition, the optimization engine 120 would also obtain a deviation between the inventory policy's associated future demand model, and the random future demand generated for each simulation.

Once the deviation data is available, the optimization engine 120 sends the deviation data to the cost analysis engine 140 to estimate a policy cost for each inventory policy.

According to an embodiment, estimating the policy cost for each inventory policy comprises determining a cost incurred in each simulation that is run for the inventory policy.

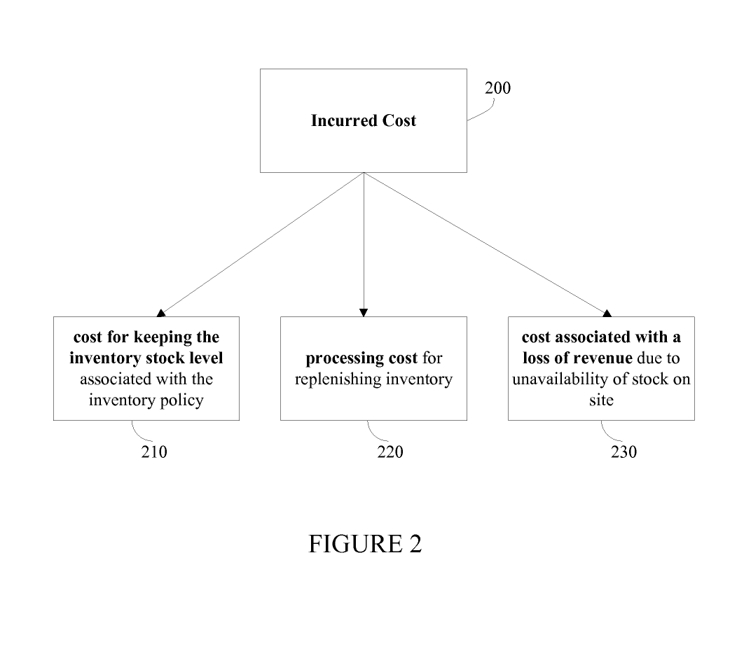

As illustrated in FIG. 2, according to an embodiment, the cost incurred 200 comprises a cost for keeping the inventory stock level associated with the inventory policy 210, a processing cost for replenishing inventory 220 and a cost associated with a loss of revenue due to unavailability of stock on site 230. A policy cost for the inventory policy therefore is a function of the incurred costs that are determined for the plurality of simulations.

Referring back to FIG. 1, the optimization engine 120 is further configured to receive the policy cost for each inventory policy from the cost analysis engine 140, the optimization engine 120 stores the policy costs along with the plurality of inventory policies in the Inventory Policy Data Repository 150. The optimization engine 120 is further configured to rank the plurality of inventory policies according to the policy costs and configure the output device 170 to present the ranking of the plurality of inventory policies to a user. The output device 170 can be a screen or a monitor of a computer or any other information presentation device.

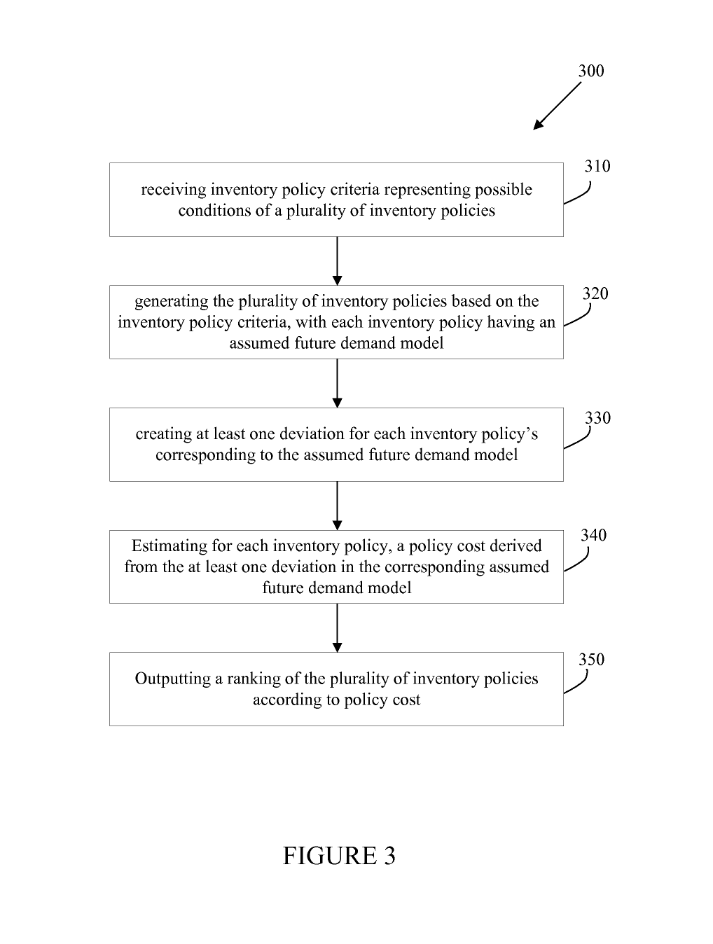

FIG. 3 illustrates a process 300 for identifying an optimized inventory policy. In some embodiments, the process 300 is performed by the system 100 of FIG. 1. As shown, the process 300 begins by receiving (at step 310) inventory policy criteria that represent possible conditions for several inventory policies. In some embodiments the inventory policy criteria is received through an inventory interface from a user.

Next, the process generates (at step 320) several inventory policies based on the received inventory policy criteria. In some embodiments, each of the generated inventory policy is associated with an assumed future demand model. The process then obtains (at step 330) at least one deviation for the assumed future demand model associated with each of the generated inventory policies. In some embodiments, the deviations are obtained by running multiple simulations for each of the inventory policies.

Different embodiments use different implementations in obtaining the deviation for the assumed future demand models. As mentioned above, some embodiments of the invention uses the Monte Carlo method to first generate a probability distribution over a range of future demands of a particular item. The process then performs multiple (e.g., 50, 100, 1,000, etc.) simulations for each inventory policy. Each simulation is performed using a demand parameter that is randomly generated according to the probability distribution. The process then calculates the cost to maintain each inventory policy in the simulation. The cost is used to estimate (at step 340) a policy cost for each inventory policy. After estimating the policy costs, the process ranks (at step 350) the inventory policies according to the policy costs.

The steps of the method illustrated in FIG. 3 and described above herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, micro controller, or state machine. A processor may also be implemented as a combination of computing devices, e.g., a combination of a DSP and a microprocessor, a plurality of microprocessors, one or more microprocessors in conjunction with a DSP core, or any other such configuration.

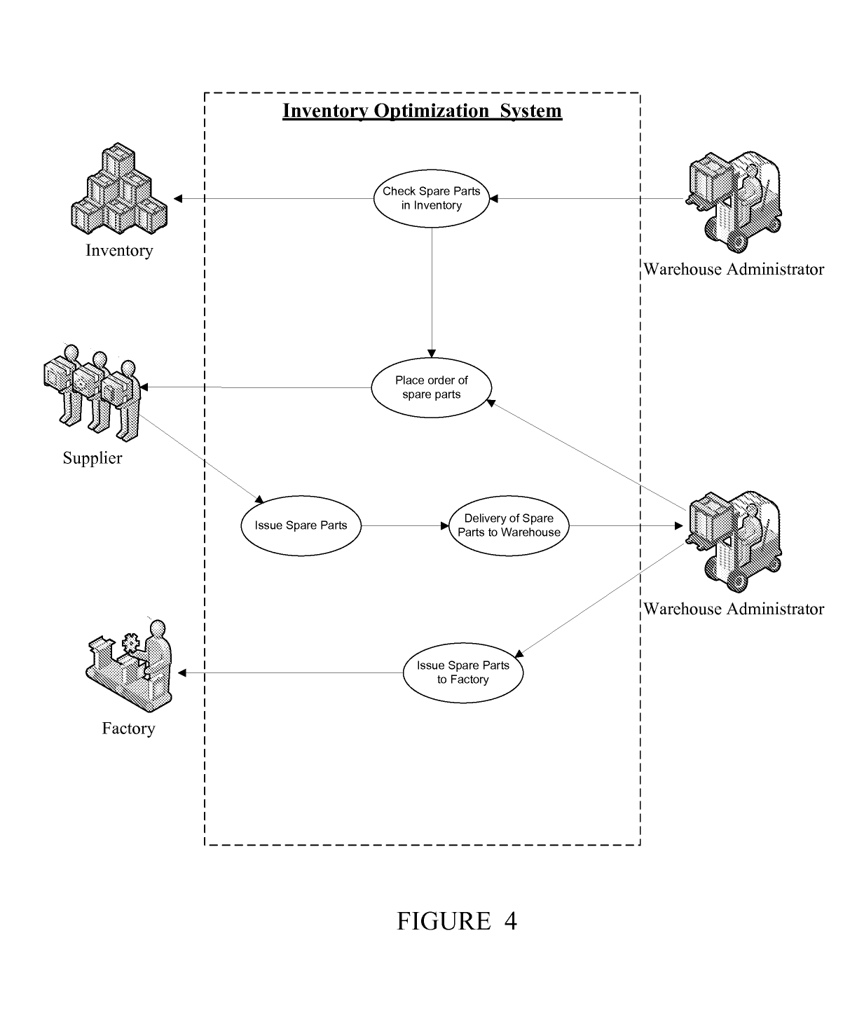

FIG. 4 is a use case diagram illustrating an example environment in which the method of the present invention can be effectively utilized. The environment illustrated is a spare parts logistics network involving a supplier entity who supplies the spare parts, a factory entity who consumes the spare parts and a warehouse entity who stocks the spare parts. A representative of the warehouse such as a warehouse administrator or any other suitable person checks the stock of spare parts in the inventory and if found below a reorder point, places an order to a supplier. The supplier may check the order and issue the required spare parts to the warehouse. The warehouse may issue the spare parts to the factory as and when the factory needs the same. The method described in accordance with the present invention may be implemented in one embodiment by the warehouse administrator.

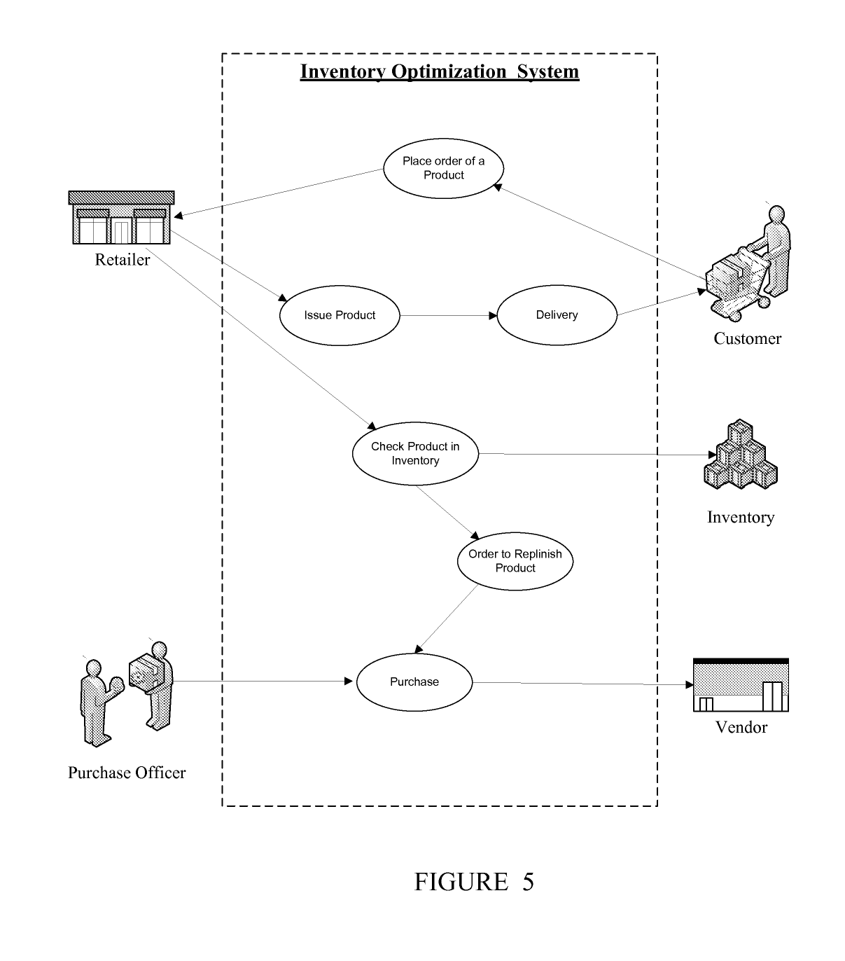

FIG. 5 is a use case diagram illustrating another example environment in which the method of the present invention can be beneficially utilized. The environment illustrated is a typical business to customer scenario wherein a customer purchases a product from a retailer and the retailer maintains their inventory. The customer places an order for a product with a retailer. The retailer issues the product as requested in the order and deliver the product to the customer. A representative of the retailer such as an administrator or any other suitable person checks the stock of products in the inventory and if found below a reorder point, places an order to replenish the product via a vendor. The method described in accordance with the present invention may be implemented in one embodiment by the retailer.

A detailed example of identifying an optimized inventory policy in accordance with an embodiment of the invention will be described below. The assumptions for the example are as follows:
XYZ Pvt. Ltd. is a Construction Company that frequently place orders for bags of cement.
At the start of the process, XYZ Pvt. Ltd. has 7 bags of cement.
The unit cost per bag of cement is $100.
Cost of holding a bag of cement in inventory warehouse for 1 month is $5.
If (Inventory—Present predicted Demand)≦Reorder Point); place re-order as per the policy.
If (Predicted Demand>(Inventory in hand+Ordered Quantity)); place stock-out cost for the shortage to meet the predicted demand.
Loss of stock-out is priced at 25$ per bag.

Keeping in view the above basics, the first starting point would be to predict demand probability in accordance with Monte Carlo Simulation (MCS). We are assuming the demand is predicted for 7 months (including the current month) in accordance with Monte Carlo Simulation (MCS). MCS does not predict an exact number of bags in demand for each month. Instead, a probability of distribution curve using the Monte Carlo method is generated to simulate the demand for bags of cement during a period of 7 months. For example, the probability distribution can include the following:
40% chance the demand in each month for the next 7 months is 5 bags of cement on average;
20% chance the demand in each month for the next 7 months is 3 bags of cement on average;
20% chance the demand in each month for the next 7 months is 6 bags of cement on average; and
20% chance the demand in each month for the next 7 months is 4 bags of cement on average.

Thereafter, a number of simulations (e.g., 50 simulations) may be executed. In each simulation, the probability distribution is used to generate the demand for the next 7 months. For example, using the probability distribution above, the first 5 simulations might look like this:

| | Demand for each month |
|---|---|
| Simulations. | for the next 7 months |
| 1. | 5 |
| 2. | 3 |
| 3. | 5 |
| 4. | 6 |
| 5. | 4 |

Thereafter, the method involves defining plurality of policies. It may be noted that the aforesaid steps i.e. predicting the demand can be done even after defining the plurality of policies. Once the predicted demand and the plurality of policies are available, the method proceeds to evaluate each of the policy as per the predicted demand to find the best-suited policy for a particular demand prediction.

By way of example, lets us assume that a total of 3 policies are generated by the optimization engine 120 based on the input criteria, and are as follows:

### Policy No. 1:

The reorder point is 3 bags of cement (i.e., whenever the inventory is at 3 bags of cement, a reorder is triggered) and the quantity ordered (reorder level) is 4 bags of cement at one time such that the inventory warehouse when left with 3 bags of cement or less than 3, places an order of 4 bags of cement to replenish the inventory.

If the monthly demand (as predicted by MCS) cannot be satisfied completely from in-hand inventory, then the excess demand is a loss of opportunity or stock-out cost.

Now, let us evaluate the 5 demand simulations having future demands of 5, 3, 5, 6 and 4 for policy 1:
For the matter of convenience, the following abbreviations are used in the tables below:

| | |
|---|---|
| Months | M |
| Inventory in Hand | IH |
| Ordered Quantity | OQ |
| Predicted Demand | PD |
| Stock-out Quantity | SoQ |
| Inventory Leftover | IL |
| Stock-Out cost | SoC |
| Cost of holding | CoH |

TABLE 1
Evaluation of Policy 1 for a predicted
7-month demand of 5 (bags) per month

| M | IH | OQ | PD | SoQ | IL | SoC | CoH | Conclusion |
|---|---|---|---|---|---|---|---|---|
| 1 | 7 | — | 5 | — | 2 | — | $10 | Quantity Ordered - 4 |
| | | | | | | | | bags for next month. |
| | | | | | | | | No stock-out cost for |
| | | | | | | | | this month. |
| 2 | 2 | 4 | 5 | — | 1 | — | $5 | Quantity Ordered - 4 |
| | | | | | | | | bags for next month. |
| | | | | | | | | No stock-out cost for |
| | | | | | | | | this month. |
| 3 | 1 | 4 | 5 | — | 0 | — | — | Quantity Ordered - 4 |
| | | | | | | | | bags for next month. |
| | | | | | | | | No stock-out cost for |
| | | | | | | | | this month. |
| 4 | 0 | 4 | 5 | 1 | 0 | $25 | — | Quantity Ordered - 4 |
| | | | | | | | | bags for next month. |
| | | | | | | | | Stock-out is 1 bag |
| | | | | | | | | for this month. |
| 5 | 0 | 4 | 5 | 1 | 0 | $25 | — | Quantity Ordered - 4 |
| | | | | | | | | bags for next month. |
| | | | | | | | | Stock-out is 1 bag |
| | | | | | | | | for this month. |
| 6 | 0 | 4 | 5 | 1 | 0 | $25 | — | Quantity Ordered - 4 |
| | | | | | | | | bags for next month. |
| | | | | | | | | Stock-out is 1 bag |
| | | | | | | | | for this month. |
| 7 | 0 | 4 | 5 | 1 | 0 | $25 | | No Quantity Ordered |
| | | | | | | | | for next month. Stock- |
| | | | | | | | | out is 1 bag for this |
| | | | | | | | | month. |

| | | |
|---|---|---|
| Individual Total | $100 | $15 |

| | |
|---|---|
| Grand Total | $115 |

As per table 1, XYZ Pvt. Ltd. would incur stock-out expenses or loss of opportunity expenses in the months 4, 5, 6 and 7 as the demand for bags of cement is considerably higher than the inventory in hand. Stock-out cost for the 4th-7th months is $25 for each month, thereby making the total stock-out cost for 7 months to $100.

As per the above table, the cost of holding a bag of cement is $5. So, the cost for holding bags of cement as per above table is: Month 1=$10, Month 2=$5, Month 3=$0, Month 4=$0, Month 5=$0, Month 6=$0 and Month 7=$0. So, the total cost for holding bags of cement in the 7 months are $15.

Thereby, the grand total cost the company would incur by following Policy 1 for the aforesaid predicted demand (5) is $115 (inventory holding costs+stock-out cost).

It is noted that Ordered Quantity is the number of bags of cement ordered in the previous month that is received in the current month.

TABLE 2
Evaluation of Policy 1 for a predicted
7-month demand of 3 (bags) per month

| M | IH | OQ | PD | SoQ | IL | SoC | CoH | Conclusion |
|---|---|---|---|---|---|---|---|---|
| 1 | 7 | — | 3 | — | 4 | — | $20 | No Quantity Ordered for |
| | | | | | | | | next month. No stock-out |
| | | | | | | | | cost for this month. |
| 2 | 4 | — | 3 | — | 1 | — | $5 | Quantity Ordered - 4 |
| | | | | | | | | bags for next month. |
| | | | | | | | | No stock-out cost for |
| | | | | | | | | this month. |
| 3 | 1 | 4 | 3 | — | 2 | — | $10 | Quantity Ordered - 4 |
| | | | | | | | | bags for next month. |
| | | | | | | | | No stock-out cost for |
| | | | | | | | | this month. |
| 4 | 2 | 4 | 3 | — | 3 | — | $15 | Quantity Ordered - 4 |
| | | | | | | | | bags for next month. |
| | | | | | | | | No stock-out cost for |
| | | | | | | | | this month. |
| 5 | 3 | 4 | 3 | — | 4 | — | $20 | No Quantity Ordered for |
| | | | | | | | | next month. No stock-out |
| | | | | | | | | cost for this month. |
| 6 | 4 | — | 3 | — | 1 | — | $5 | Quantity Ordered - 4 |
| | | | | | | | | bags for next month. |
| | | | | | | | | No stock-out cost for |
| | | | | | | | | this month. |
| 7 | 1 | 4 | 3 | — | 2 | — | $10 | No Quantity Ordered for |
| | | | | | | | | next month. No stock-out |
| | | | | | | | | cost for this month. |

| | | |
|---|---|---|
| Individual Total | — | $85 |

| | |
|---|---|
| Grand Total | $85 |

Going by table 2, it can be noticed that the grand total cost the company would incur by following Policy 1 for the aforesaid predicted demand (3) is $85 (inventory holding costs+stock-out cost).

TABLE 3
Evaluation of Policy 1 for
a predicted 7-month demand of 5 (bags) per month

| M | IH | OQ | PD | SoQ | IL | SoC | CoH | Conclusion |
|---|---|---|---|---|---|---|---|---|
| 1 | 7 | — | 5 | — | 2 | — | $10 | Quantity Ordered - |
| | | | | | | | | 4 bags for next month. |
| | | | | | | | | No stock-out cost |
| | | | | | | | | for this month. |
| 2 | 2 | 4 | 5 | — | 1 | — | $5 | Quantity Ordered - |
| | | | | | | | | 4 bags for next month. |
| | | | | | | | | No stock-out cost |
| | | | | | | | | for this month. |
| 3 | 1 | 4 | 5 | — | 0 | — | — | Quantity Ordered - |
| | | | | | | | | 4 bags for next month. |
| | | | | | | | | No stock-out cost |
| | | | | | | | | for this month. |
| 4 | 0 | 4 | 5 | 1 | 0 | $25 | — | Quantity Ordered - |
| | | | | | | | | 4 bags for next month. |
| | | | | | | | | Stock-out is 1 |
| | | | | | | | | bag for this month. |
| 5 | 0 | 4 | 5 | 1 | 0 | $25 | — | Quantity Ordered - |
| | | | | | | | | 4 bags for next month. |
| | | | | | | | | Stock-out is 1 |
| | | | | | | | | bag for this month. |
| 6 | 0 | 4 | 5 | 1 | 0 | $25 | — | Quantity Ordered - |
| | | | | | | | | 4 bags for next month. |
| | | | | | | | | Stock-out is 1 |
| | | | | | | | | bag for this month. |
| 7 | 0 | 4 | 5 | 1 | 0 | $25 | | No Quantity Ordered for |
| | | | | | | | | next month. Stock-out is |
| | | | | | | | | 1 bag for this month. |

| | | |
|---|---|---|
| Individual Total | $100 | $15 |

| | |
|---|---|
| Grand Total | $115 |

Going by table 3, it can be noticed that the grand total cost the company would incur by following Policy 1 for the aforesaid predicted demand (5) is $115 (inventory holding costs+stock-out cost).

TABLE 4
Evaluation of Policy 1 for
a predicted 7-month demand of 6 (bags) per month

| M | IH | OQ | PD | SoQ | IL | SoC | CoH | Conclusion |
|---|---|---|---|---|---|---|---|---|
| 1 | 7 | — | 6 | — | 1 | — | $5 | Quantity Ordered - |
| | | | | | | | | 4 bags for next month. |
| | | | | | | | | No stock-out cost |
| | | | | | | | | for this month. |
| 2 | 1 | 4 | 6 | 1 | 0 | $25 | — | Quantity Ordered - |
| | | | | | | | | 4 bags for next month. |
| | | | | | | | | Stock-out is 1 bags |
| | | | | | | | | for this month. |
| 3 | 0 | 4 | 6 | 2 | 0 | $50 | — | Quantity Ordered - |
| | | | | | | | | 4 bags for next month. |
| | | | | | | | | Stock-out is 2 bags |
| | | | | | | | | for this month. |
| 4 | 0 | 4 | 6 | 2 | 0 | $50 | — | Quantity Ordered - |
| | | | | | | | | 4 bags for next month. |
| | | | | | | | | Stock-out is 2 bags |
| | | | | | | | | for this month. |
| 5 | 0 | 4 | 6 | 2 | 0 | $50 | — | Quantity Ordered - |
| | | | | | | | | 4 bags for next month. |
| | | | | | | | | Stock-out is 2 bags |
| | | | | | | | | for this month. |
| 6 | 0 | 4 | 6 | 2 | 0 | $50 | — | Quantity Ordered - |
| | | | | | | | | 4 bags for next month. |
| | | | | | | | | Stock-out is 2 bags |
| | | | | | | | | for this month. |
| 7 | 0 | 4 | 6 | 2 | 0 | $50 | — | No Quantity Ordered for |
| | | | | | | | | next month. Stock-out is |
| | | | | | | | | 2 bags for this month. |

| | | |
|---|---|---|
| Individual Total | $275 | $5 |

| | |
|---|---|
| Grand Total | $280 |

Going by table 4, it can be noticed that the grand total cost the company would incur by following Policy 1 for the aforesaid predicted demand (6) is $280 (inventory holding costs+stock-out cost).

TABLE 5
Evaluation of Policy 1 for
a predicted 7-month demand of 4 (bags) per month

| M | IH | OQ | PD | SoQ | IL | SoC | CoH | Conclusion |
|---|---|---|---|---|---|---|---|---|
| 1 | 7 | — | 4 | — | 3 | — | $15 | Quantity Ordered - 4 |
| | | | | | | | | bags for next month. |
| | | | | | | | | No stock-out cost for |
| | | | | | | | | this month. |
| 2 | 3 | 4 | 4 | — | 3 | — | $15 | Quantity Ordered - 4 |
| | | | | | | | | bags for next month. |
| | | | | | | | | No stock-out cost for |
| | | | | | | | | this month. |
| 3 | 3 | 4 | 4 | — | 3 | — | $15 | Quantity Ordered - 4 |
| | | | | | | | | bags for next month. |
| | | | | | | | | No stock-out cost for |
| | | | | | | | | this month. |
| 4 | 3 | 4 | 4 | — | 3 | — | $15 | Quantity Ordered - 4 |
| | | | | | | | | bags for next month. |
| | | | | | | | | No stock-out cost for |
| | | | | | | | | this month. |
| 5 | 3 | 4 | 4 | — | 3 | — | $15 | Quantity Ordered - 4 |
| | | | | | | | | bags for next month. |
| | | | | | | | | No stock-out cost for |
| | | | | | | | | this month. |
| 6 | 3 | 4 | 4 | — | 3 | — | $15 | Quantity Ordered - 4 |
| | | | | | | | | bags for next month. |
| | | | | | | | | No stock-out cost for |
| | | | | | | | | this month. |
| 7 | 3 | 4 | 4 | — | 3 | — | $15 | No Quantity Ordered |
| | | | | | | | | for next month. No |
| | | | | | | | | stock-out cost for this |
| | | | | | | | | month. |

| | | |
|---|---|---|
| Individual Total | — | $105 |

| | |
|---|---|
| Grand Total | $105 |

Going by table 5, it can be noticed that the grand total cost the company would incur by following Policy 1 for the aforesaid predicted demand (4) is $105 (inventory holding costs+stock-out cost).

### Policy No. 2:

The reorder point is 2 bags of cement and the quantity ordered (reorder level) is 3 bags of cement at one time such that the inventory warehouse when left with 2 bags of cement or less than 2, places an order of 3 bags of cement to replenish the inventory.

If the monthly demand (as predicted by MCS) cannot be satisfied completely from in-hand inventory, then the excess demand is a loss of opportunity or stock-out cost.

Now, let us evaluate the 5 demand simulations having future demands of 5, 3, 5, 6 and 4 for policy 2.

TABLE 6
Evaluation of Policy 2 for
a predicted 7-month demand of 5 (bags) per month

| M | IH | OQ | PD | SoQ | IL | SoC | CoH | Conclusion |
|---|---|---|---|---|---|---|---|---|
| 1 | 7 | — | 5 | — | 2 | — | $10 | Quantity Ordered - 3 |
| | | | | | | | | bags for next month. |
| | | | | | | | | No stock-out cost |
| | | | | | | | | for this month. |
| 2 | 2 | 3 | 5 | — | 0 | — | — | Quantity Ordered - 3 |
| | | | | | | | | bags for next month. |
| | | | | | | | | No stock-out cost |
| | | | | | | | | for this month. |
| 3 | 0 | 3 | 5 | 2 | 0 | $50 | — | Quantity Ordered - 3 |
| | | | | | | | | bags for next month. |
| | | | | | | | | Stock-out is 2 bags |
| | | | | | | | | for this month. |
| 4 | 0 | 3 | 5 | 2 | 0 | $50 | — | Quantity Ordered - 3 |
| | | | | | | | | bags for next month. |
| | | | | | | | | Stock-out is 2 bags |
| | | | | | | | | for this month. |
| 5 | 0 | 3 | 5 | 2 | 0 | $50 | — | Quantity Ordered - 3 |
| | | | | | | | | bags for next month. |
| | | | | | | | | Stock-out is 2 bags |
| | | | | | | | | for this month. |
| 6 | 0 | 3 | 5 | 2 | 0 | $50 | — | Quantity Ordered - 3 |
| | | | | | | | | bags for next month. |
| | | | | | | | | Stock-out is 2 bags |
| | | | | | | | | for this month. |
| 7 | 0 | 3 | 5 | 2 | 0 | $50 | — | No Quantity Ordered for |
| | | | | | | | | next month. Stock-out is |
| | | | | | | | | 2 bags for this month. |

| | | |
|---|---|---|
| Individual Total | $250 | $10 |

| | |
|---|---|
| Grand Total | $260 |

Going by table 6, it can be noticed that the grand total cost the company would incur by following Policy 2 for the aforesaid predicted demand (5) is $260 (inventory holding costs+stock-out cost).

TABLE 7
Evaluation of Policy 2 for
a predicted 7-month demand of 3 (bags) per month

| M | IH | OQ | PD | SoQ | IL | SoC | CoH | Conclusion |
|---|---|---|---|---|---|---|---|---|
| 1 | 7 | — | 3 | — | 4 | — | $20 | No Quantity Ordered for |
| | | | | | | | | next month. No stock-out |
| | | | | | | | | cost for this month. |
| 2 | 4 | — | 3 | — | 1 | — | $5 | Quantity Ordered - 3 |
| | | | | | | | | bags for next month. |
| | | | | | | | | No stock-out cost for |
| | | | | | | | | this month. |
| 3 | 1 | 3 | 3 | — | 1 | — | $5 | Quantity Ordered - 3 |
| | | | | | | | | bags for next month. |
| | | | | | | | | No stock-out cost for |
| | | | | | | | | this month. |
| 4 | 1 | 3 | 3 | — | 1 | — | $5 | Quantity Ordered - 3 |
| | | | | | | | | bags for next month. |
| | | | | | | | | No stock-out cost for |
| | | | | | | | | this month. |
| 5 | 1 | 3 | 3 | — | 1 | — | $5 | Quantity Ordered - 3 |
| | | | | | | | | bags for next month. |
| | | | | | | | | No stock-out cost for |
| | | | | | | | | this month. |
| 6 | 1 | 3 | 3 | — | 1 | — | $5 | Quantity Ordered - 3 |
| | | | | | | | | bags for next month. |
| | | | | | | | | No stock-out cost for |
| | | | | | | | | this month. |
| 7 | 1 | 3 | 3 | — | 1 | — | $5 | No Quantity Ordered for |
| | | | | | | | | next month. No stock-out |
| | | | | | | | | cost for this month. |

| | | |
|---|---|---|
| Individual Total | — | $50 |

| | |
|---|---|
| Grand Total | $50 |

Going by table 7, it can be noticed that the grand total cost the company would incur by following Policy 2 for the aforesaid predicted demand (3) is $50 (inventory holding costs+stock-out cost).

TABLE 8
Evaluation of Policy 2 for
a predicted 7-month demand of 5 (bags) per month

| M | IH | OQ | PD | SoQ | IL | SoC | CoH | Conclusion |
|---|---|---|---|---|---|---|---|---|
| 1 | 7 | — | 5 | — | 2 | — | $10 | Quantity Ordered - 3 |
| | | | | | | | | bags for next month. |
| | | | | | | | | No stock-out cost for |
| | | | | | | | | this month. |
| 2 | 2 | 3 | 5 | — | 0 | — | — | Quantity Ordered - 3 |
| | | | | | | | | bags for next month. |
| | | | | | | | | No stock-out cost for |
| | | | | | | | | this month. |
| 3 | 0 | 3 | 5 | 2 | 0 | $50 | — | Quantity Ordered - 3 |
| | | | | | | | | bags for next month. |
| | | | | | | | | Stock-out is 2 bags for |
| | | | | | | | | this month. |
| 4 | 0 | 3 | 5 | 2 | 0 | $50 | — | Quantity Ordered - 3 |
| | | | | | | | | bags for next month. |
| | | | | | | | | Stock-out is 2 bags for |
| | | | | | | | | this month. |
| 5 | 0 | 3 | 5 | 2 | 0 | $50 | — | Quantity Ordered - 3 |
| | | | | | | | | bags for next month. |
| | | | | | | | | Stock-out is 2 bags for |
| | | | | | | | | this month. |
| 6 | 0 | 3 | 5 | 2 | 0 | $50 | — | Quantity Ordered - 3 |
| | | | | | | | | bags for next month. |
| | | | | | | | | Stock-out is 2 bags for |
| | | | | | | | | this month. |
| 7 | 0 | 3 | 5 | 2 | 0 | $50 | — | No Quantity Ordered for |
| | | | | | | | | next month. Stock-out is |
| | | | | | | | | 2 bags for this month. |

| | | |
|---|---|---|
| Individual Total | $250 | $10 |

| | |
|---|---|
| Grand Total | $260 |

Going by table 8, it can be noticed that the grand total cost the company would incur by following Policy 2 for the aforesaid predicted demand (5) is $260 (inventory holding costs+stock-out cost).

TABLE 9
Evaluation of Policy 2 for
a predicted 7-month demand of 6 (bags) per month

| M | IH | OQ | PD | SoQ | IL | SoC | CoH | Conclusion |
|---|---|---|---|---|---|---|---|---|
| 1 | 7 | — | 6 | — | 1 | — | $5 | Quantity Ordered - 3 |
| | | | | | | | | bags for next month. |
| | | | | | | | | No stock-out cost |
| | | | | | | | | for this month. |
| 2 | 1 | 3 | 6 | 2 | 0 | $50 | — | Quantity Ordered - 3 |
| | | | | | | | | bags for next month. |
| | | | | | | | | Stock-out is 2 bags |
| | | | | | | | | for this month. |
| 3 | 0 | 3 | 6 | 3 | 0 | $75 | — | Quantity Ordered - 3 |
| | | | | | | | | bags for next month. |
| | | | | | | | | Stock-out is 3 bags |
| | | | | | | | | for this month. |
| 4 | 0 | 3 | 6 | 3 | 0 | $75 | — | Quantity Ordered - 3 |
| | | | | | | | | bags for next month. |
| | | | | | | | | Stock-out is 3 bags |
| | | | | | | | | for this month. |
| 5 | 0 | 3 | 6 | 3 | 0 | $75 | — | Quantity Ordered - 3 |
| | | | | | | | | bags for next month. |
| | | | | | | | | Stock-out is 3 bags |
| | | | | | | | | for this month. |
| 6 | 0 | 3 | 6 | 3 | 0 | $75 | — | Quantity Ordered - 3 |
| | | | | | | | | bags for next month. |
| | | | | | | | | Stock-out is 3 bags |
| | | | | | | | | for this month. |
| 7 | 0 | 3 | 6 | 3 | 0 | $75 | — | No Quantity Ordered for |
| | | | | | | | | next month. Stock-out |
| | | | | | | | | is 3 bags for this month. |

| | | |
|---|---|---|
| Individual Total | $425 | $5 |

| | |
|---|---|
| Grand Total | $430 |

Going by table 9, it can be noticed that the grand total cost the company would incur by following Policy 2 for the aforesaid predicted demand (6) is $430 (inventory holding costs+stock-out cost).

TABLE 10
Evaluation of Policy 2 for
a predicted 7-month demand of 4 (bags) per month

| M | IH | OQ | PD | SoQ | IL | SoC | CoH | Conclusion |
|---|---|---|---|---|---|---|---|---|
| 1 | 7 | — | 4 | — | 3 | — | $15 | No Quantity Ordered for |
| | | | | | | | | next month. No stock-out |
| | | | | | | | | cost for this month. |
| 2 | 3 | — | 4 | 1 | 0 | $25 | — | Quantity Ordered - 3 |
| | | | | | | | | bags for next month. |
| | | | | | | | | Stock-out is 1 bag |
| | | | | | | | | for this month. |
| 3 | 0 | 3 | 4 | 1 | 0 | $25 | — | Quantity Ordered - 3 |
| | | | | | | | | bags for next month. |
| | | | | | | | | Stock-out is 1 bag |
| | | | | | | | | for this month. |
| 4 | 0 | 3 | 4 | 1 | 0 | $25 | — | Quantity Ordered - 3 |
| | | | | | | | | bags for next month. |
| | | | | | | | | Stock-out is 1 bag |
| | | | | | | | | for this month. |
| 5 | 0 | 3 | 4 | 1 | 0 | $25 | — | Quantity Ordered - 3 |
| | | | | | | | | bags for next month. |
| | | | | | | | | Stock-out is 1 bag |
| | | | | | | | | for this month. |
| 6 | 0 | 3 | 4 | 1 | 0 | $25 | — | Quantity Ordered - 3 |
| | | | | | | | | bags for next month. |
| | | | | | | | | Stock-out is 1 bag |
| | | | | | | | | for this month. |
| 7 | 0 | 3 | 4 | 1 | 0 | $25 | — | No Quantity Ordered for |
| | | | | | | | | next month. Stock-out is |
| | | | | | | | | 1 bag for this month. |

| | | |
|---|---|---|
| Individual Total | $150 | $15 |

| | |
|---|---|
| Grand Total | $165 |

Going by table 10, it can be noticed that the grand total cost the company would incur by following Policy 2 for the aforesaid predicted demand (4) is $165 (inventory holding costs+stock-out cost).

### Policy No. 3:

The reorder point is 1 bag of cement and the quantity ordered (reorder level) is 5 bags of cement at one time such that the inventory warehouse when left with 1 bag of cement or less than 1, places an order of 5 bags of cement to replenish the inventory.

If the monthly demand (as predicted by MCS) cannot be satisfied completely from in-hand inventory, then the excess demand is a loss of opportunity or stock-out cost.

Now, let us evaluate the 5 demand simulations having future demands of 5, 3, 5, 6 and 4 for policy.

TABLE 11
Evaluation of Policy 3 for
a predicted 7-month demand of 5 (bags) per month

| M | IH | OQ | PD | SoQ | IL | SoC | CoH | Conclusion |
|---|---|---|---|---|---|---|---|---|
| 1 | 7 | — | 5 | — | 2 | — | $10 | No Quantity Ordered for |
| | | | | | | | | next month. No stock-out |
| | | | | | | | | cost for this month. |
| 2 | 2 | — | 5 | 3 | — | $75 | — | Quantity Ordered - 5 |
| | | | | | | | | bags for next month. |
| | | | | | | | | Stock-out is 3 bags |
| | | | | | | | | for this month. |
| 3 | 0 | 5 | 5 | — | — | — | — | Quantity Ordered - 5 |
| | | | | | | | | bags for next month. |
| | | | | | | | | No stock-out cost |
| | | | | | | | | for this month. |
| 4 | 0 | 5 | 5 | — | — | — | — | Quantity Ordered - 5 |
| | | | | | | | | bags for next month. |
| | | | | | | | | No stock-out cost |
| | | | | | | | | for this month. |
| 5 | 0 | 5 | 5 | — | — | — | — | Quantity Ordered - 5 |
| | | | | | | | | bags for next month. |
| | | | | | | | | No stock-out cost |
| | | | | | | | | for this month. |
| 6 | 0 | 5 | 5 | — | — | — | — | Quantity Ordered - 5 |
| | | | | | | | | bags for next month. |
| | | | | | | | | No stock-out cost for |
| | | | | | | | | this month. |
| 7 | 0 | 5 | 5 | — | — | — | — | No Quantity Ordered for |
| | | | | | | | | next month. No stock-out |
| | | | | | | | | cost for this month. |

| | | |
|---|---|---|
| Individual Total | $75 | $10 |

| | |
|---|---|
| Grand Total | $85 |

Going by table 11, it can be noticed that the grand total cost the company would incur by following Policy 3 for the aforesaid predicted demand (5) is $85 (inventory holding costs+stock-out cost).

TABLE 12
Evaluation of Policy 3 for
a predicted 7-month demand of 3 (bags) per month

| M | IH | OQ | PD | SoQ | IL | SoC | CoH | Conclusion |
|---|---|---|---|---|---|---|---|---|
| 1 | 7 | — | 3 | — | 4 | — | $20 | No Quantity Ordered |
| | | | | | | | | for next month. No |
| | | | | | | | | stock-out cost for this |
| | | | | | | | | month. |
| 2 | 4 | — | 3 | — | 1 | — | $5 | Quantity Ordered - 5 |
| | | | | | | | | bags for next month. |
| | | | | | | | | No stock-out cost for |
| | | | | | | | | this month. |
| 3 | 1 | 5 | 3 | — | 3 | — | $15 | No Quantity Ordered |
| | | | | | | | | for next month. No |
| | | | | | | | | stock-out cost for this |
| | | | | | | | | month. |
| 4 | 3 | — | 3 | — | 0 | — | — | Quantity Ordered - 5 |
| | | | | | | | | bags for next month. |
| | | | | | | | | No stock-out cost for |
| | | | | | | | | this month. |
| 5 | 0 | 5 | 3 | — | 2 | — | $10 | No Quantity Ordered |
| | | | | | | | | for next month. No |
| | | | | | | | | stock-out cost for this |
| | | | | | | | | month. |
| 6 | 2 | — | 3 | 1 | 0 | $25 | — | Quantity Ordered - 5 |
| | | | | | | | | bags for next month. |
| | | | | | | | | Stock-out is 1 bag for |
| | | | | | | | | this month. |
| 7 | 0 | 5 | 3 | — | 2 | — | $10 | No Quantity Ordered |
| | | | | | | | | for next month. No |
| | | | | | | | | stock-out cost for this |
| | | | | | | | | month. |

| | | |
|---|---|---|
| Individual Total | $25 | $60 |

| | |
|---|---|
| Grand Total | $85 |

Going by table 12, it can be noticed that the grand total cost the company would incur by following Policy 3 for the aforesaid predicted demand (3) is $85 (inventory holding costs+stock-out cost).

TABLE 13
Evaluation of Policy 3 for
a predicted 7-month demand of 5 (bags) per month

| M | IH | OQ | PD | SoQ | IL | SoC | CoH | Conclusion |
|---|---|---|---|---|---|---|---|---|
| 1 | 7 | — | 5 | — | 2 | — | $10 | No Quantity Ordered for |
| | | | | | | | | next month. No stock-out |
| | | | | | | | | cost for this month. |
| 2 | 2 | — | 5 | 3 | — | $75 | — | Quantity Ordered - 5 |
| | | | | | | | | bags for next month. |
| | | | | | | | | Stock-out is 3 bags |
| | | | | | | | | for this month. |
| 3 | 0 | 5 | 5 | — | — | — | — | Quantity Ordered - 5 |
| | | | | | | | | bags for next month. |
| | | | | | | | | No stock-out cost |
| | | | | | | | | for this month. |
| 4 | 0 | 5 | 5 | — | — | — | — | Quantity Ordered - 5 |
| | | | | | | | | bags for next month. |
| | | | | | | | | No stock-out cost |
| | | | | | | | | for this month. |
| 5 | 0 | 5 | 5 | — | — | — | — | Quantity Ordered - 5 |
| | | | | | | | | bags for next month. |
| | | | | | | | | No stock-out cost |
| | | | | | | | | for this month. |
| 6 | 0 | 5 | 5 | — | — | — | — | Quantity Ordered - 5 |
| | | | | | | | | bags for next month. |
| | | | | | | | | No stock-out cost |
| | | | | | | | | for this month. |
| 7 | 0 | 5 | 5 | — | — | — | — | No Quantity Ordered for |
| | | | | | | | | next month. No stock-out |
| | | | | | | | | cost for this month. |

| | | |
|---|---|---|
| Individual Total | $75 | $10 |

| | |
|---|---|
| Grand Total | $85 |

Going by table 13, it can be noticed that the grand total cost the company would incur by following Policy 3 for the aforesaid predicted demand (5) is $85 (inventory holding costs+stock-out cost).

TABLE 14
Evaluation of Policy 3 for
a predicted 7-month demand of 6 (bags) per month

| M | IH | OQ | PD | SoQ | IL | SoC | CoH | Conclusion |
|---|---|---|---|---|---|---|---|---|
| 1 | 7 | — | 6 | — | 1 | — | $5 | Quantity Ordered - 5 |
| | | | | | | | | bags for next month. |
| | | | | | | | | No stock-out cost for |
| | | | | | | | | this month. |
| 2 | 1 | 5 | 6 | — | 0 | — | — | Quantity Ordered - 5 |
| | | | | | | | | bags for next month. |
| | | | | | | | | No stock-out cost for |
| | | | | | | | | this month. |
| 3 | 0 | 5 | 6 | 1 | 0 | $25 | — | Quantity Ordered - 5 |
| | | | | | | | | bags for next month. |
| | | | | | | | | Stock-out is 1 bag for |
| | | | | | | | | this month. |
| 4 | 0 | 5 | 6 | 1 | 0 | $25 | — | Quantity Ordered - 5 |
| | | | | | | | | bags for next month. |
| | | | | | | | | Stock-out is 1 bag for |
| | | | | | | | | this month. |
| 5 | 0 | 5 | 6 | 1 | 0 | $25 | — | Quantity Ordered - 5 |
| | | | | | | | | bags for next month. |
| | | | | | | | | Stock-out is 1 bag for |
| | | | | | | | | this month. |
| 6 | 0 | 5 | 6 | 1 | 0 | $25 | — | Quantity Ordered - 5 |
| | | | | | | | | bags for next month. |
| | | | | | | | | Stock-out is 1 bag for |
| | | | | | | | | this month. |
| 7 | 0 | 5 | 6 | 1 | 0 | $25 | — | No Quantity Ordered for |
| | | | | | | | | next month. Stock-out is |
| | | | | | | | | 1 bag for this month. |

| | | |
|---|---|---|
| Individual Total | $125 | $5 |

| | |
|---|---|
| Grand Total | $130 |

Going by table 14, it can be noticed that the grand total cost the company would incur by following Policy 3 for the aforesaid predicted demand (6) is $130 (inventory holding costs+stock-out cost).

TABLE 15
Evaluation of Policy 3 for
a predicted 7-month demand of 4 (bags) per month

| M | IH | OQ | PD | SoQ | IL | SoC | CoH | Conclusion |
|---|---|---|---|---|---|---|---|---|
| 1 | 7 | — | 4 | — | 3 | — | $15 | No Quantity Ordered |
| | | | | | | | | for next month. No |
| | | | | | | | | stock-out cost for this |
| | | | | | | | | month. |
| 2 | 3 | — | 4 | 1 | 0 | $25 | — | Quantity Ordered - 5 |
| | | | | | | | | bags for next month. |
| | | | | | | | | Stock-out is 1 bag for |
| | | | | | | | | this month. |
| 3 | 0 | 5 | 4 | — | 1 | — | $5 | Quantity Ordered - 5 |
| | | | | | | | | bags for next month. |
| | | | | | | | | No stock-out cost for |
| | | | | | | | | this month. |
| 4 | 1 | 5 | 4 | — | 2 | — | $10 | No Quantity Ordered |
| | | | | | | | | for next month. No |
| | | | | | | | | stock-out cost for this |
| | | | | | | | | month. |
| 5 | 2 | — | 4 | 2 | 0 | $50 | — | Quantity Ordered - 5 |
| | | | | | | | | bags for next month. |
| | | | | | | | | Stock-out is 2 bags for |
| | | | | | | | | this month. |
| 6 | 0 | 5 | 4 | — | 1 | — | $5 | Quantity Ordered - 5 |
| | | | | | | | | bags for next month. |
| | | | | | | | | No stock-out cost for |
| | | | | | | | | this month. |
| 7 | 1 | 5 | 4 | — | 2 | — | $10 | No Quantity Ordered |
| | | | | | | | | for next month. No |
| | | | | | | | | stock-out cost for this |
| | | | | | | | | month. |

| | | |
|---|---|---|
| Individual Total | $75 | $45 |

| | |
|---|---|
| Grand Total | $120 |

Going by table 15, it can be noticed that the grand total cost the company would incur by following Policy 3 for the aforesaid predicted demand (4) is $120 (inventory holding costs+stock-out cost).

Now, lets look at the table 16 provided below which compares the average cost incurred by every policy using the same demand simulation. It is now possible to rank such plurality of inventory policies according to cost.

| | Simulation | | |
|---|---|---|---|
| Policy | Future | | |
| No. | Demands | Average Cost ($) | Rank |
| 1 | 5, 3, 5, 6 and 4 | (115 + 85 + 115 + 280 + 105)/5 = 140 | 2 |
| 2 | 5, 3, 5, 6 and 4 | (260 + 50 + 260 + 430 + 165)/5 = 233 | 3 |
| 3 | 5, 3, 5, 6 and 4 | (85 + 85 + 85 + 130 + 120)/5 = 101 | 1 |

From the above table, it can be seen that by following the policy no 3, the total cost incurred would be least.

This example will produce much clearer results when used with a large number of simulations. However, we may not see much deviation in the results (as above) when the number of simulations increases.

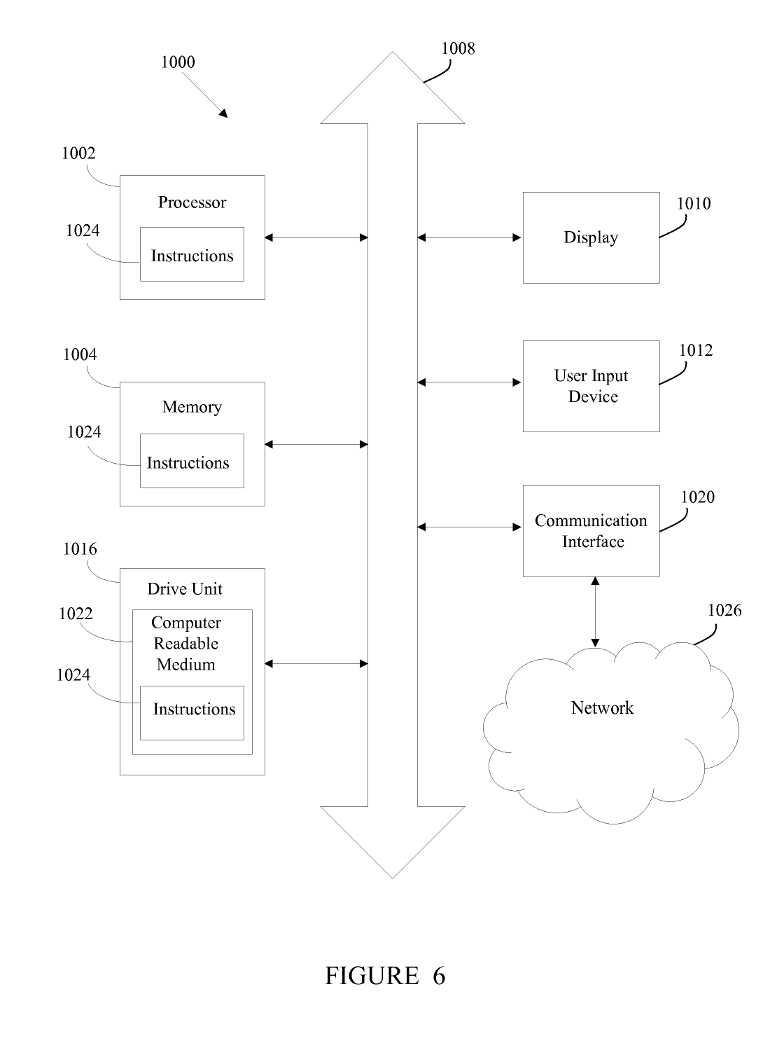

FIG. 6 illustrates a typical hardware configuration of a computer system, which is representative of a hardware environment for practicing the present invention. The computer system 1000 may include a processor 1002, e.g., a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data The processor 1002 may implement a software program, such as code generated manually (i.e., programmed).

The term “module” may be defined to include a plurality of executable modules. In some embodiments, the inventory interface 110, the optimization engine 120, the simulation engine 130, the cost analysis engine 140 of FIG. 1 are implemented as modules of the inventory optimization system 100. As described herein, the modules are defined to include software, hardware or some combination thereof executable by a processor, such as processor 1002. Software modules may include instructions stored in memory, such as memory 1004, or another memory device, that are executable by the processor 1002 or other processor. Hardware modules may include various devices, components, circuits, gates, circuit boards, and the like that are executable, directed, or otherwise controlled for performance by the processor 1002.

The computer system 1000 may include a memory 1004, such as a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1004 includes a cache or random access memory for the processor 1002. In alternative examples, the memory 1004 is separate from the processor 1002, such as a cache memory of a processor, the system memory, or other memory. The memory 1004 may be an external storage device or database for storing data. In some embodiments, the inventory policy data repository 150 of FIG. 1 is implemented as a database that is stored in the memory 1004. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination Likewise, processing strategies may include multiprocessing, multitasking, parallel processing and the like.

As shown, the computer system 1000 may or may not further include a display unit 1010, such as a liquid crystal display (LCD), an organic light emitting diode (OLED), a flat panel display, a solid state display, a cathode ray tube (CRT), a projector, a printer or other now known or later developed display device for outputting determined information. The display 1010 may act as an interface for the user to see the functioning of the processor 1002, or specifically as an interface with the software stored in the memory 1004 or in the drive unit 1016.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the computer system 1000.

The computer system 1000 may also include a disk or optical drive unit 1016. The disk drive unit 1016 may include a computer-readable medium 1022 in which one or more sets of instructions 1024, e.g. software, can be embedded. Further, the instructions 1024 may embody one or more of the methods or logic as described. In a particular example, the instructions 1024 may reside completely, or at least partially, within the memory 1004 or within the processor 1002 during execution by the computer system 1000. The memory 1004 and the processor 1002 also may include computer-readable media as discussed above.

The present invention contemplates a computer-readable medium that includes instructions 1024 or receives and executes instructions 1024 responsive to a propagated signal so that a device connected to a network 1026 can communicate voice, video, audio, images or any other data over the network 1026. Further, the instructions 1024 may be transmitted or received over the network 1026 via a communication port or interface 1020 or using a bus 1008. The communication port or interface 1020 may be a part of the processor 1002 or may be a separate component. The communication port 1020 may be created in software or may be a physical connection in hardware. The communication port 1020 may be configured to connect with a network 1026, external media, the display 1010, or any other components in system 1000, or combinations thereof. The connection with the network 1026 may be a physical connection, such as a wired Ethernet connection or may be established wirelessly as discussed later. Likewise, the additional connections with other components of the system 1000 may be physical connections or may be established wirelessly. The network 1026 may alternatively be directly connected to the bus 1008.

The network 1026 may include wired networks, wireless networks, Ethernet AVB networks, or combinations thereof. The wireless network may be a cellular telephone network, an 802.11, 802.16, 802.20, 802.1Q or WiMax network. Further, the network 1026 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed. The “computer-readable medium” may be non-transitory, and may be tangible.

In an example, the computer-readable medium can include a solid-state memory such as a memory card or other package that houses one or more nonvolatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement various parts of the system 1000.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of identifying an optimized inventory policy, comprising:
providing an interface configured to receive inventory policy criteria representing possible conditions of a plurality of inventory policies by which an inventory could be managed;
providing access to an optimization engine coupled with the interface and configured to receive the inventory policy criteria via the interface;
generating, by the optimization engine, the plurality of inventory policies based on the inventory policy criteria, each inventory policy having an assumed future demand model;
obtaining, by the optimization engine, at least one deviation for each inventory policy's corresponding future demand model;
estimating, by the optimization engine, for each inventory policy in the plurality of inventory policies, a policy cost derived from the at least one deviation in the corresponding assumed future demand model; and
configuring, by the optimization engine, an output device to present a ranking of the plurality of inventory policies according to policy cost.

2. The inventory optimization method of claim 1, wherein the inventory comprises machinery spare parts.

3. The inventory optimization method of claim 1, wherein the inventory comprises products for sale.

4. The inventory optimization method of claim 1, wherein the criteria comprises a range of inventory levels.

5. The inventory optimization method of claim 4, wherein generating the plurality of different inventory policies comprises determining, for each of the plurality of different inventory policies, a set of rules governing a maintenance of an inventory level within the range of inventory levels.

6. The inventory optimization method of claim 5, wherein the set of rules that governs the maintenance of the inventory level for each inventory policy is associated with the inventory policy's corresponding assumed future demand model.

7. The inventory optimization method of claim 1, wherein obtaining the deviation for each inventory policy's corresponding future demand model comprises:
generating a probability distribution over a range of future stock demands; and
performing a plurality of simulations on managing the inventory over a time period, each of the plurality of simulations being performed based on the inventory policy and a future stock demand randomly generated according to the probability distribution.

8. The inventory optimization method of claim 7, wherein estimating the policy cost for each inventory policy comprises determining, for each simulation, a cost incurred by a deviation between the assumed demand model associated with the inventory policy and the future stock demand randomly generated for the simulation.

9. The inventory optimization method of claim 8, wherein the incurred cost comprises a cost for keeping the inventory stock level associated with the inventory policy, a processing cost for replenishing inventory, and a cost associated with a loss of revenue due to unavailability of stock on site.

10. The inventory optimization method of claim 8, wherein the policy cost for the inventory policy is a function of the incurred costs that are determined for the plurality of simulations.

11. An inventory optimization system, comprising:
an interface configured to receive inventory policy criteria representing possible conditions of a plurality of inventory policies by which an inventory could be managed;
an optimization engine coupled to the interface and configured to (i) receive the inventory policy criteria via the interface, (ii) generate the plurality of inventory policies based on the inventory policy criteria, each inventory policy having an assumed future demand model, (iii) obtain at least one deviation for each inventory policy's corresponding assumed future demand model; (iv) estimate, for each inventory policy in the plurality of inventory policies, a policy cost derived from the at least one deviation in the corresponding assumed future demand model, and (v) configure an output device to present a ranking of the plurality of inventory policies according to policy cost.

12. The inventory optimization system of claim 11, wherein the inventory comprises machinery spare parts.

13. The inventory optimization system of claim 11, wherein the inventory comprises products for sale.

14. The inventory optimization system of claim 11, wherein the criteria comprises a range of inventory levels.

15. The inventory optimization system of claim 14, wherein the optimization engine is further configured to determine, for each of the plurality of different inventory policies, a set of rules governing a maintenance of an inventory level within the range of inventory levels.

16. The inventory optimization system of claim 5, wherein the set of rules that governs the maintenance of the inventory level for each inventory policy is associated with the inventory policy's corresponding assumed future demand model.

17. The inventory optimization system of claim 11, wherein the optimization engine is future configured to (i) generate a probability distribution over a range of future stock demands and (ii) perform a plurality of simulations on managing the inventory over a time period, each of the plurality of simulations being performed based on the inventory policy and a future stock demand randomly generated according to the probability distribution.

18. The inventory optimization system of claim 17, wherein estimating the policy cost for each inventory policy comprises determining, for each simulation, a cost incurred by a deviation between the assumed demand model associated with the inventory policy and the future stock demand randomly generated for the simulation.

19. The inventory optimization system of claim 18, wherein the incurred cost comprises a cost for keeping the inventory stock level associated with the inventory policy, a processing cost for replenishing inventory, and a cost associated with a loss of revenue due to unavailability of stock on site.

20. The inventory optimization system of claim 18, wherein the policy cost for the inventory policy is a function of the incurred costs that are determined for the plurality of simulations.
